(19) United States
(12) Patent Application Publication
(10) Pub. No.: US 2002/0023702 A1
(43) Pub. Date: Feb. 28, 2002

(54) Floorboard

(76) Inventor: Volker Kettler, Worther (DE)

Correspondence Address: STEVENS, DAVIS, MILLER & MOSHER, L.L.P., Suite 850, 1615 L Street, N.W., Washington, DC, 20036, US

(21) Appl. No.: 09/862,462

(22) Filed: May 23, 2001

(30) Foreign Application Priority Data
Jul. 1, 2000 (DE) 100 32 204.2

(51) Int. Cl. B31D 1/00

(52) U.S. Cl. 156/62.2; 156/278

(57) ABSTRACT

A floorboard, in particular a laminate panel, parquet element or such like, made from a derived timber product, in particular a highly compressed medium or high-density fiberboard, has peripheral edges which are connected with the edges of adjacent boards. These edges are provided with an edge impregnation which serves in the first instance to prevent moisture from penetrating into the board. The edge impregnation can consist of, or contain, a pest control agent.

This invention relates to a floorboard, in particular a laminate panel, parquet element, flooring panel or such like made from a derived timber product, in particular a highly compressed medium or high-density fiberboard, with a top decorative layer, a bottom opposite layer, peripheral edges, in particular with a connecting profile for the purpose of connecting adjacent boards, and a edge impregnation on the peripheral edges.

Floorboards of this type are disclosed in utility models 295 17 995 U1 and 296 10 462 U1. In these publications an edge impregnation is applied to the peripheral edges, which is intended to prevent the penetration of moisture, which can cause the boards to swell up. Whilst the top and bottom surfaces of such boards are generally provided with a very stable and wear-resistant coating which is also largely moistureproof, the unprotected derived timber material is exposed at the edges which are usually cut and profiled. Moisture can therefore penetrate at this point and cause swelling in a floorboard because the derived timber material that is used is relatively hygroscopic.

EP 903 451 A2 describes another floorboard whose peripheral edge is impregnated with a soaling agent to achieve improved resistance to moisture. The floorboards are intended to be laid against adjacent boards with or without adhesive. An adhesive coating is described in numerous other documents.

Despite these edge coatings, joints remain between the individual boards in which dust and dirt can collect. Although this could be prevented by moistureproof adhesion and sealing, the preference is often for laying the boards without adhesive. This is simpler, causes no soiling during the board laying process, can be carried out by laypersons and, above all, allows the flooring to be removed again relatively easily if there is any damage to be repaired, or the flooring is to be changed.

This invention is therefore based on the task of designing floorboards of the above type so that even with flooring laid with joints, pests of all kinds can be prevented from collecting in the joints.

In a floorboard of the above type, this task is solved according to the invention in that the edge impregnation consists of, or contains, a fungicide, insecticide, bactericide, pesticide, disinfectant or some other pest control agent.

The edge impregnation can therefore consist solely of the pest control agent of the type described above insofar as a moisture barrier layer is not required or not envisaged for other reasons, or may be combined with such a moisture barrier layer or another impregnation. In this context the term combined always means that the pest control agent is either mixed with another edge impregnation serving a different purpose, in particular a moisture-repellent agent, or that the pest control agent is applied consecutive to this other agent in two operations. Whatever the case, the pest control agent is intended to prevent pollen, fungal spores or other microorganisms harmful to human health, which may be brought in with e.g. house dust, from developing in the joints. It is known that this type of development is generally promoted by moisture, so that it is particularly expedient to combine the pest control agent with a liquid barrier layer which prevents moisture from penetrating into and collecting inside the porous structure of the fiberboard.

In this context, the term pests is used to mean all substances or organisms which are harmful to human health, so that the concept of the pest control agent includes all types of remedies suitable for controlling the effects of such substances or organisms. Pest control agents in this sense therefore also include anti-allergic agents.

When controlling such organisms it is not, however, necessary to exterminate the latter with the control agent. It is sufficient to ensure that the agents suppress or inhibit the development of the microbes or their ability to reproduce, or influence their detrimental impact on health in some other way. For example, certain microbiocides affect the metabolism of bacteria so that the latter are no longer capable of absorbing any food and cannot therefore continue to reproduce.

Alternatively, one can use the types of products which are familiar as e.g. domestic disinfectant-cleaners,; e.g. alcohols, acetic or formic acids, strong alkalis, in particular bleaching powder (hypochlorites), aldehydes, phenol derivatives and quaternary ammonium compounds or organotin compounds.

Compounds based on isothiazolinone structures are suitable to prevent the formation of mould, rot and such like. As already mentioned, the use of this pest control agent in combination/mixed with an edge impregnation intended to provide protection against moisture is particularly advantageous.

It is obvious that one can only use products which are not themselves harmful to human health. The products must therefore essentially be ones which are approved e.g. for domestic use.

Preferred embodiments of the invention will be explained in more detail below with reference to the enclosed drawings, in which

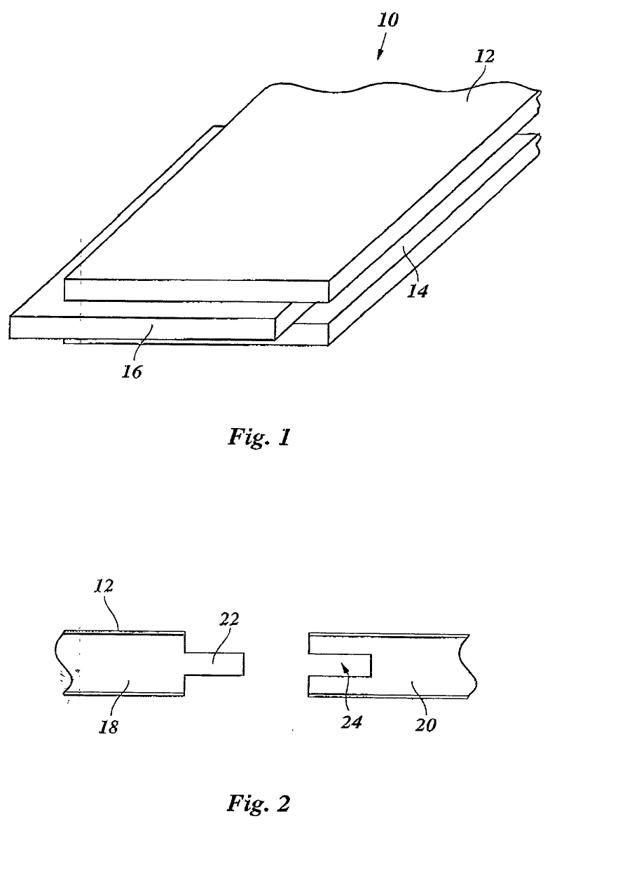

FIG. 1 is a perspective partial view of a floorboard with a peripheral edge provided for a groove and tongue connection with adjacent boards;

FIG. 2 is a vertical partial section through the edge portions of two adjacent boards to be connected to each other.

In FIG. 1, 10 designates an overall floorboard. The top surface 12 of this board is provided with e.g. a decorative coating in the form of graining, which is largely impervious to water as a general rule. There is a counter coating on the bottom side, which is not shown.

The edge oriented to the right in FIG. 1 is provided with a groove 14, whilst the edges on the sides to the front and left of FIG. 1 form a projecting tongue 16.

Groove and tongue boards of this type have long been used for floor and wall coverings. In the case of floor coverings, they keep adjacent boards rigid in relation to each other in the vertical direction and prevent adjacent boards from moving or warping relative to each other in the perpendicular direction. With today s widely used floor panels made from derived timber panels, the simple groove and tongue connections have been developed further into connections which also provide a locking function in the horizontal direction between adjacent boards. This type of edge design is not, however, specifically the subject of this application.

FIG. 2 shows the facing edge portions of two adjacent floorboards 18,20. Whilst the floorboard is shown on the left in FIG. 2 is provided with a projecting tongue 22, a groove 24 is contrived in the edge of the floorboard 20 on the right. When the two boards are pushed together the groove and tongue interact in the known manner.

Insofar as the two boards are not bonded or sealed over in a joint-tight manner, a joint (not shown) forms between the two boards after the laying operation, into which moisture can penetrate e.g. from the air, or when the floor is washed with water or other liquids. As the boards are made from derived timber products, the profiled edges, which are not provided with any coating, are more or less hygroscopic, so that they absorb and retain moisture. This is the reason why the floorboards 18 and 20 according to the invention are preferably provided with a moisture barrier layer over their entire edge surface areas.

In the Applicant s two utility models mentioned above, consideration is given to numerous materials suitable for producing this barrier layer such as e.g. polyester epoxide acrylates or urethane resins and/or polyurethane polymers based on aliphatic and/or aromatic isocyanates as well as oils, waxes and oil-wax mixtures. The materials can be sprayed on, printed on or applied in some other way. During the application process they can be diluted with solvents to facilitate penetration into the porous structure of the derived timber products. When using natural or synthetic waxes, work can be carried out with heat, which causes the waxes to melt. It is also possible to use materials which harden with ultrasound or ultraviolet light, or with the addition of oxidatively acting drying agents (siccatives). Details will be found in the Applicant s cited utility models. These moisture-excluding edge impregnating agents are mixed or combined with suitable pest control agents of the type described above. Both agents can also be applied one after the other.

The pest control agents can also be stored or encapsulated in a carrier substance and only be released from the latter in the event of concentrated contact with moisture, high temperatures or certain chemical reactions or mechanical stress.

The word pest control agent is used here in its widest sense. It is intended to include all agents which facilitate the control, suppression, inhibition etc. of all types of micro-organisms representing a threat to human health.

1. A floorboard, in particular a laminate panel, parquet element or flooring panel or such like, made from a derived timber product, in particular a highly compressed medium or high-density fiberboard, with a top decorative layer, a bottom opposite layer, peripheral edges, in particular with a connecting profile for the purpose of connecting adjacent boards, and an edge impregnation on the peripheral edges, characterized in that the edge impregnation consists of, or contains, a fungicide, insecticide, bactericide, pesticide, disinfectant or other pest control agents.

2. The floorboard of claim 1, characterized in that the edge impregnation consists of an agent for forming a liquid barrier layer, with which a pest control agent is mixed.

3. The floorboard of claim 1, characterized in that the edge impregnation consists of an agent for forming a liquid barrier layer and a pest control agent which is applied after the latter solidifies or hardens.

4. The floorboard of claim 1, characterized in that the edge impregnation consists solely of a pest control agent.

5. The floorboard of one of claims 1 to 4, characterized in that the pest control agent is stored or encapsulated in a carrier substance which only releases the agent dependent on a certain moisture level, temperature, chemical reaction or mechanical influences.

6. The floorboard of one of the preceding claims, characterized in that the pest control agent is formed on the basis of a disinfectant-cleaner suitable for domestic use.

7. The floorboard of one of the preceding claims, characterized in that the pest control agent is formed from alcohol, acetic acid, formic acid, strong alkalis, in particular bleaching powder (hypochlorites), aldehydes, phenol derivatives and quaternary ammonium compounds or organotin compounds.

8. The floorboard of one of the preceding claims, characterized in that the pest control agent consists of compounds based on isothiazolinone structures to prevent the formation of mould, rot, etc.
